(19) United States
(12) Patent Application Publication
(10) Pub. No.: US 2006/0178795 A1
(43) Pub. Date: Aug. 10, 2006

(54) Method for automating the opening and/or closing of vehicle opening elements

(76) Inventors: Gerard Queveau, Le Pin (FR); Paul Queveau, Montravers (FR); Marc Baudeau, Bretignolles (FR); Regis Dubreuil, Cholet (FR)

Correspondence Address: YOUNG & THOMPSON, 745 SOUTH 23RD STREET, 2ND FLOOR, ARLINGTON, VA, 22202, US

(21) Appl. No.: 11/302,152

(22) Filed: Dec. 14, 2005

(30) Foreign Application Priority Data
Dec. 14, 2004 (FR) 0452981

(51) Int. Cl. E05F 15/00

(52) U.S. Cl. 701/49

(57) ABSTRACT

A method for automatic opening and closing of opening elements (2) of a vehicle (1) pivoting about at least two articulations makes provision to protect interference zones (ZAP1, ZAP2, ZAP3, ZAP4, ZAP5) by having at least one presence detector and/or at least one contact detector and including the steps: Emitting of a control signal for opening or closing the opening element or elements (2); Respectively the automatic and complete opening or closing of the opening element or elements (2) during which the following are performed: Monitoring of the occurrence of interference, using the detectors, which, in the event of interference being detected, generates a detection signal; and Processing of the detection signal by a calculation unit which generates an activation signal controlling the device for activating the opening element or elements (2) according to an operating mode adapted to the situation detected.

The invention concerns a method for automatic opening and closing of a vehicle opening element. It also concerns a vehicle able to be converted into a convertible using this method.

The invention applies to opening elements such as doors or tailgates. The invention applies most particularly to opening elements found for example on vehicles able to be converted into a convertible. It then concerns foldable, rigid or flexible retractable roofs and luggage compartment lids with a double direction of opening.

In particular, one objective of the invention is to fully automate the opening and/or closing movement of such opening elements. Another of its objectives is to automatically trigger such movements and monitor any interference between a human body or an external body and the opening elements during such movements.

Automatic systems for closing and opening car opening elements, and interference monitoring systems for opening elements such as doors or door windows, are known from the prior art.

However, there is no complete monitoring system proposing to monitor all types of interference. This is because one of the major problems that arises, during opening or closing a vehicle opening element, is to protect both:

People or objects against being pinched between moving parts and fixed parts of the vehicle;

Moving parts against interference with obstacles situated in the surroundings of the vehicle such as a wall or a ceiling.

Moreover, the prior art does not provide for an automatic system for opening or closing opening elements with several articulations such as foldable, rigid or flexible retractable roofs and luggage compartment lids with a double direction of opening. In this particular case, the problem is particularly tricky to solve since the opening elements have several articulations and therefore in their movements sweep through larger volumes and more complex shapes.

In addition, the prior art provides for monitoring systems operating only during closing of the opening elements and not being concerned with their opening.

Finally, the prior art provides for monitoring systems active only at the end of the cycle for closing the opening element. This type of monitoring does not allow interference to be anticipated and does not allow the system to adopt an operating mode adapted to the distance separating the opening element from the interference.

The aim of the invention is to solve these problems by proposing a method for automating opening and closing of opening elements, particularly well adapted to opening elements of vehicles able to be converted into a convertible such as foldable, rigid or flexible retractable roofs or double-direction luggage compartment lids and proposing a complete system for detecting interference.

To that end, and according to a first aspect, the invention proposes a method for automatic opening and closing of at least one vehicle opening element pivoting about at least two articulations, the opening and closing of said opening element being activated by an activation device, said method making provision to protect interference zones by having at least one presence detector 8 and/or at least one contact detector 9, characterised in that said method comprises the following steps:

Emitting of a control signal for opening or closing the opening element or elements;

Respectively the automatic and complete opening or closing of the opening element or elements during which the following are performed:

Monitoring of the occurrence of interference, using the detectors, which, in the event of interference being detected, generates a detection signal; and

Processing of the detection signal by a calculation unit 18 which generates an activation signal controlling the means for activating the opening element or elements according to an operating mode adapted to the situation detected.

Thus, the invention has the aim of automating, and making entirely safe, the opening and closing of opening elements. Advantageously, it thus makes it possible to have a large number of remote control means such as telephony, the Internet, telecontrol, a sensor, etc. without risking damaging the vehicle or injuring a person. This is because automation implies increased protection as regards people and external bodies.

According to a second aspect, the invention concerns a vehicle 1 able to be converted into a convertible equipped with at least one presence detector 8 and/or at least one contact detector 9, means for activating at least one opening element, and a calculation unit, and whose opening element is constituted by a retractable roof and/or a luggage compartment lid 2, the retractable roof being movable between a position where it covers the passenger compartment of the vehicle 1 and a storage position situated away from the passenger compartment, it being possible for the luggage compartment lid 2 to open from the front towards the rear for storing the roof and from the rear towards the front for accessing a luggage storage space, said vehicle being characterised in that it is equipped with means for controlling a movement for automatic opening and/or closing of the opening element or elements, means for monitoring these opening elements and means for processing a detection signal generating a signal for activating the opening element or elements enabling implementation of the method.

The other characteristics of the invention emerge from the following description of one embodiment, said description being given with reference to the accompanying figures in which:

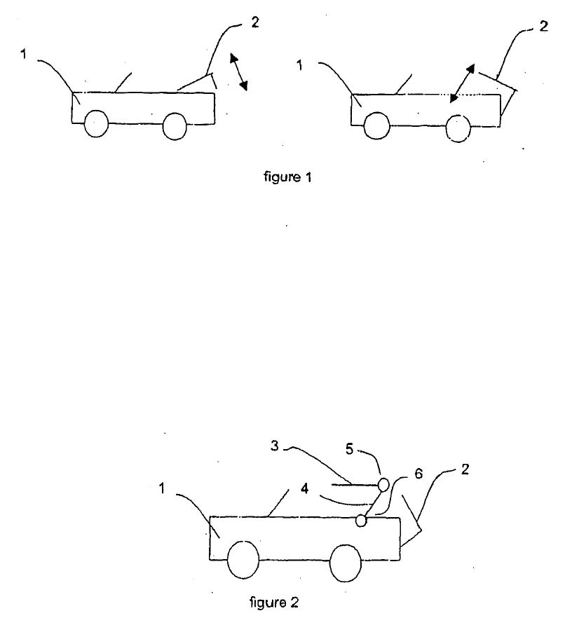

FIG. 1 is a diagram depicting the opening movements of a double-direction luggage compartment lid;

FIG. 2 is a diagram depicting the movement of a retractable roof;

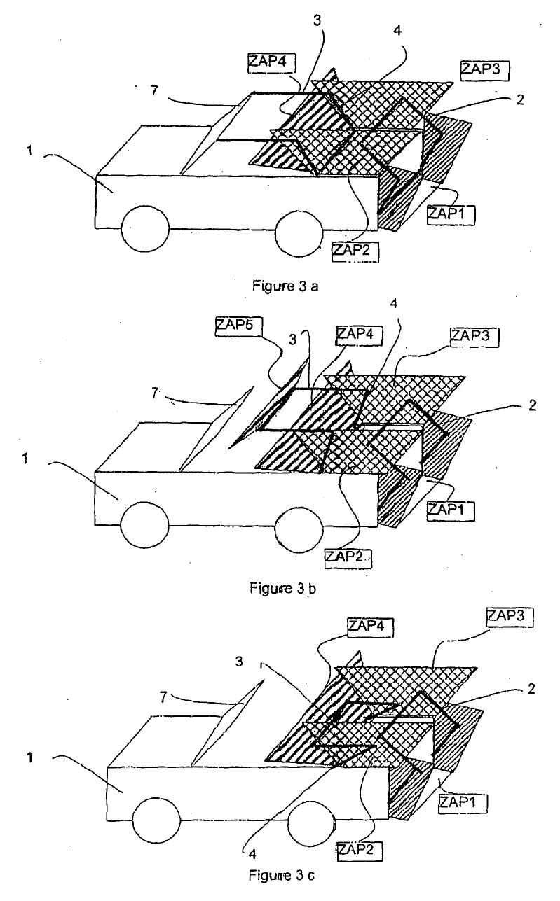

FIGS. 3a, 3b, 3c are diagrams of zones to be protected (ZAPs) from interference for a vehicle having a retractable roof and a luggage compartment with double direction of opening;

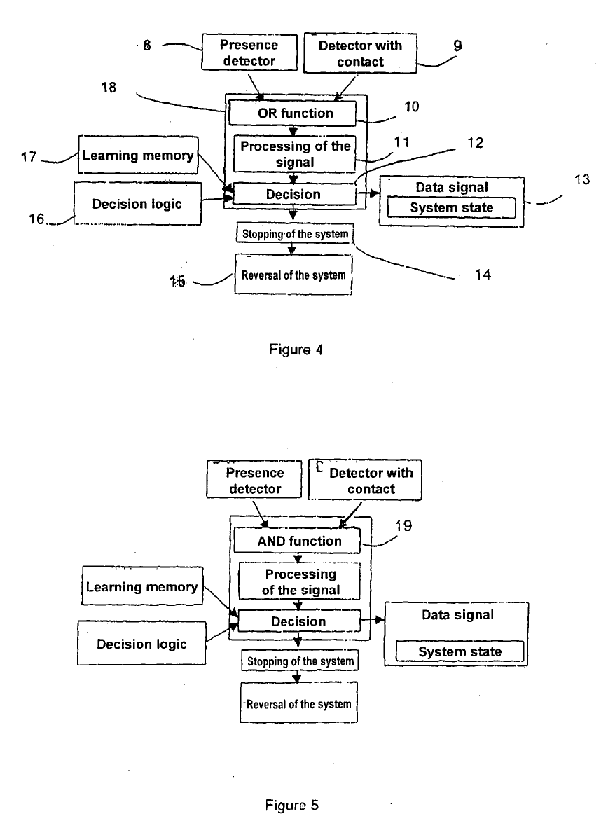

FIG. 4 is an overview diagram of the anti-pinch system operating with the OR function;

FIG. 5 is an overview diagram of the anti-pinch system operating with the AND function;

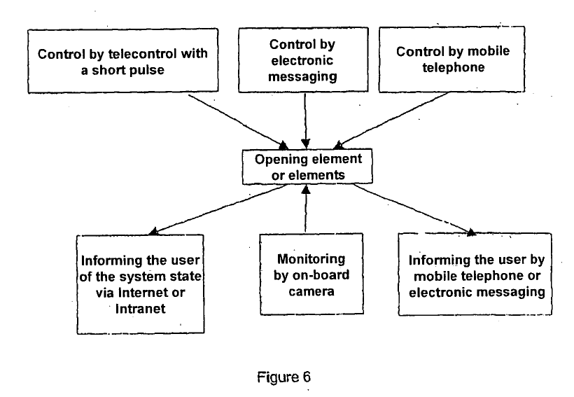

FIG. 6 is a functional diagram depicting examples of control signal emitters and example implementations of data signals.

According to one embodiment of the invention detailed in FIG. 1, the luggage compartment lid 2 of the vehicle 1 has two directions of opening. The luggage compartment lid 2 can thus rotate about a first articulation, from the rear towards the front, in order to allow access to the luggage or about a second articulation, from the front towards the rear, in order to allow storage of the opening roof.

According to the embodiment detailed in FIG. 2, the retractable roof consists of two elements: a rear element 4 and a front element 3. The rear roof element 4 is articulated with the structure of the vehicle and can rotate about a first articulation 6 in order to come to be housed in the part of the luggage compartment provided for that purpose. The front element 3 is articulated about a movable second articulation 5 situated between the two elements in order to come to lie flat against the rear element 4.

Thus, according to the embodiments detailed in FIGS. 1 and 2, the luggage compartment lid and the retractable roof have two articulations.

The means for activating the opening elements comprise electric and/or hydraulic actuators and devices for locking and unlocking the opening elements with one another on the one hand and with respect to the structure of the vehicle 1 on the other hand.

Where the kinetic energy of the system is too great, provision can be made to apply a braking device.

The operation of the method for automatic opening or closing of the opening element or elements is as follows:

A control signal is emitted and triggers a cycle for opening or closing the opening elements. This control signal can be emitted by various means, depicted in FIG. 6: switch, remote control system, Internet, Intranet, electronic messaging, telephony, atmospheric event detector (rain sensor, light sensor, etc.), intrusion detector.

Of course, the control method described above can be used independently of the method for opening and closing opening elements described in this patent application.

During this opening cycle, detectors monitor zones to be protected (ZAPs). The invention provides for at least one presence detector 8 (or contactless detector) making it possible to detect interference from a distance or at least one detector with a contact 9. In a variant, provision can be made to combine the use of at least one presence detector 8 and at least one detector with a contact 9.

Presence detectors 8 or contactless detectors can use remote detection technologies referred to as scanning detection (electromagnetic wave, frequency wave, optical or capacitive).

Detectors with contacts 9 can be mechanical systems with springs or deformable systems with shape memory such as rubber seals or strips also referred to as peripheral detection.

According to one embodiment of the invention detailed in FIGS. 3a to 3d, it is possible to describe five zones to be protected (ZAPs) against interference. The zones to be protected are delimited so as to be able to monitor interference over the entire movement of the opening elements for both the opening movement and the closing movement.

ZAP 1 enables both the opening and closing of the luggage compartment lid 2 to be made safe when it is articulated in the two directions. This zone is defined in space by a volume situated at the rear of the vehicle, between the two lateral edges of the luggage compartment lid 2 and extending into the volume defined by the movement of the luggage compartment lid 2 in these two articulation directions.

ZAP 2 and ZAP 3 enable the movements of the two opening elements to be made safe. These zones are defined by volumes extending substantially in line with the lateral parts of the vehicle 1. This is because the interference zones ZAP 2 and ZAP 3 are defined by volumes extending substantially between the two articulations of the opening elements.

ZAP 4 enables the opening or closing of the opening roof to be made safe. This zone is defined in a volume situated inside the vehicle 1.

ZAP 5 enables the opening or closing of the roof to be made safe. This zone is situated between the front roof element 3 and the top of the windscreen 7 of the vehicle 1.

The detectors monitor the occurrence of interference in these ZAPs. Should interference be detected during the opening or closing of the opening element or elements, the detectors cause the emission of a detection signal.

The OR 10 or AND 19 functions, depicted in FIGS. 4 and 5, combine the two types of detection, contactless and with a contact, creating a greater possibility of detection. Contactless detections or those with contacts can be used independently.

A calculation unit 18 processes the emitted detection signal 11. Thus, the processing of the signal 11 filters the signal coming from the sensors using specific algorithms making it possible to clear the information of the environmental noise external to the system.

Using the information coming from the learning memory 17 and/or the decision logic 16 and the previously processed detection signal, the decision subsystem 12 determines an operating mode adapted to the situation detected. The calculation unit 18 transmits this operating mode in the form of an activation signal to the means for activating the opening element or elements and in the form of a data signal 13 to the user.

The adapted operating modes can be the following:

Reducing the speed when the system detects the approach of a possible human or material obstacle in order to manage the inertia of the system better;

Reversing 15 if the detection is of human origin;

Stopping the system 14 if the detection is of material origin.

The data signal 13 makes it possible to transmit to the user of the vehicle the information concerning the situation detected, the operating mode and the position of the opening element or elements. The data signal 13 can be generated in the form of pictures, sounds or messages sent via the Internet.

The data signal 13 can also trigger a warning device consisting of transmitting a visual or audible warning message to the vehicle passenger or passengers or transmitting the warning information in various forms, outside the vehicle. The warning can for example be transmitted via mobile telephone, radio, the Internet, electronic messaging or conventional alarm system.

Example data signals are depicted in FIG. 6.

The learning memory 17 contains information relating to the variable parameters of the external environment (external temperature, rain, etc.) or relating to the parameters of the roof system and of the vehicle (component wear, temperature of the oil in the hydraulic power unit, etc.).

The decision logic 16 makes it possible to determine the decision to be taken according to the parameters detected such as the nature of the obstacle, the detection location, the position of the opening element at the moment of detection, and the detection type (contact or presence).

1. A method for automatic opening and closing of at least one vehicle opening element pivoting about at least two articulations, the opening and closing of said opening element being activated by an activation device, said method making provision to protect interference zones by having at least one presence detector (8) and/or at least one contact detector (9), characterised in that said method comprises the following steps:
Emitting of a control signal for opening or closing the opening element or elements;
Respectively the automatic and complete opening or closing of the opening element or elements during which the following are performed:
Monitoring of the occurrence of interference, using the detectors, which, in the event of interference being detected, generates a detection signal; and
Processing of the detection signal by a calculation unit (18) which generates an activation signal controlling the means for activating the opening element or elements according to an operating mode adapted to the situation detected.

2. A method according to claim 1, characterised in that it makes provision to protect the interference zone ZAP 2 and/or the interference zone ZAP 3, said interference zones ZAP 2 and ZAP 3 being defined by volumes extending substantially between the two articulations of the opening elements.

3. A method according to claim 1, characterised in that the operating mode adapted to the situation detected is chosen from amongst the following actions on the movement or movements of the opening element or elements or any combinations of these actions: slowing down, stopping, partial or total reversal as far as the initial state of the opening element.

4. A method according to claim 1, characterised in that the decision subsystem (12) determines an operation adapted to the situation detected using information contained in decision logic (16) and/or a learning memory (17).

5. A method according to claim 1, characterised in that the control signal is emitted by a switch, a remote control system, mobile telephone or the Internet and then controls the opening or closing of the opening element or elements.

6. A method according to claim 1, characterised in that the control signal is emitted by a sensor such as a rain or light sensor or an intrusion sensor and then controls the opening or closing of the opening element or elements.

7. A method according to claim 1, characterised in that the calculation unit (18) also generates a data signal (13) intended for the user of the vehicle and reporting on the situation detected, the operating mode and the position of the opening element or elements.

8. A method according to claim 7, characterised in that said data signal (13) is generated in the form of pictures, sounds or messages sent via the Internet, mobile telephone or electronic messaging.

9. A method according to claim 1, characterised in that the opening element is a retractable roof comprising at least two roof elements (3,4) articulated with one another and one of which is articulated with the structure of the vehicle (1).

10. A method according to claim 1, characterised in that the opening element is a luggage compartment lid (2) articulated with the structure of the vehicle (1) in order to pivot about a first articulation (5) from the rear towards the front and about a second articulation (6) from the front towards the rear.

11. A method according to claim 1, characterised in that the presence detectors (8) can be electromagnetic wave, frequency wave, optical or capacitive detectors.

12. A method according to claim 1, characterised in that the detectors with contacts (9) can be mechanical systems with springs or deformable systems such as rubber seals or strips.

13. A vehicle able to be converted into a convertible equipped with at least one presence detector (8) and/or at least one contact detector (9), means for activating at least one opening element, and a calculation unit (18), and whose opening element is constituted by a retractable roof and/or a luggage compartment lid (2), the retractable roof being movable between a position where it covers the passenger compartment of the vehicle and a storage position situated away from the passenger compartment, it being possible for the luggage compartment lid (2) to open from the front towards the rear for storing the roof and from the rear towards the front for accessing a luggage storage space, said vehicle being characterised in that it is equipped with means for controlling a movement for automatic opening and/or closing of the opening element or elements, means for monitoring these opening elements and means for processing a detection signal generating a signal for activating the opening element or elements enabling implementation of the method according to claim 1.

14. A method according to claim 2, characterised in that the operating mode adapted to the situation detected is chosen from amongst the following actions on the movement or movements of the opening element or elements or any combinations of these actions: slowing down, stopping, partial or total reversal as far as the initial state of the opening element.

15. A method according to claim 2, characterised in that the decision subsystem (12) determines an operation adapted to the situation detected using information contained in decision logic (16) and/or a learning memory (17).

16. A method according to claim 3, characterised in that the decision subsystem (12) determines an operation adapted to the situation detected using information contained in decision logic (16) and/or a learning memory (17).

17. A method according to claim 2, characterised in that the control signal is emitted by a switch, a remote control system, mobile telephone or the Internet and then controls the opening or closing of the opening element or elements.

18. A method according to claim 3, characterised in that the control signal is emitted by a switch, a remote control system, mobile telephone or the Internet and then controls the opening or closing of the opening element or elements.

19. A method according to claim 4, characterised in that the control signal is emitted by a switch, a remote control system, mobile telephone or the Internet and then controls the opening or closing of the opening element or elements.

20. A method according to claim 2, characterised in that the control signal is emitted by a sensor such as a rain or light sensor or an intrusion sensor and then controls the opening or closing of the opening element or elements.
